(19) United States
(12) Patent Application Publication
(10) Pub. No.: US 2014/0358681 A1
(43) Pub. Date: Dec. 4, 2014

(54) CONTENT PROVISION SYSTEM AND DISTRIBUTION CONTROL METHOD

(71) Applicant: Mitsuru SATOH, Tokyo (JP)

(72) Inventor: Mitsuru SATOH, Tokyo (JP)

(73) Assignee: RICOH COMPANY, LTD., Tokyo (JP)

(21) Appl. No.: 14/289,071

(22) Filed: May 28, 2014

(30) Foreign Application Priority Data
Jun. 3, 2013 (JP) 2013-116698

(51) Int. Cl. G06Q 30/02; H04N 1/00

(52) U.S. Cl. CPC G06Q 30/0255; G06Q 30/0267; H04N 1/00281; H04N 2201/0094
USPC 705/14.53

(57) ABSTRACT

A content provision system includes an electronic device and a management system including one or more devices to manage content that is provided to a user through the electronic device. The electronic device includes a detection unit that detects a user who has used the electronic device and receives user identification information that identifies the user, and a transmission unit that transmits the user identification information to the management system. The management system includes a history management unit that manages history information which associates the user identification information with the electronic device, and a determination unit that determines the electronic device to distribute the content, and the user as an object of provision of the content based on content attributes indicating the object of provision of the content and the history information managed by the history management unit.

### BACKGROUND OF THE INVENTION

1. Field of the Invention

The present invention relates to a content provision system and a distribution control method.

2. Description of the Related Art

Nowadays, digitized advertisements are increasingly popular. For example, advertisement content may be distributed through a network and displayed on a web browser of an electronic device, such as a PC, a smart phone, a tablet, etc. In order to increase a sales promotion effect of advertisement, distributing advertisement content to a target of advertisement is needed. However, by this method, it is uncertain who views the advertisement or which tiers of consumers view the advertisement. It does not become effective and efficient advertisement.

Japanese Laid-Open Patent Publication No. 2008-094045 discloses an image forming apparatus in which advertisement information suited to a user's taste is merged into print data in order to increase the effectiveness of advertisement.

Japanese Laid-Open Patent Publication No. 2008-276437 discloses an image forming apparatus in which advertisements corresponding to jobs previously performed by the image forming apparatus are displayed for the purpose of displaying advertisement more effectively than in a conventional apparatus.

However, in the technology disclosed in Japanese Laid-Open Patent Publication No. 2008-094045, the advertisement information suited to the user's taste may be offered to a user who uses the image forming apparatus. The advertisement may not be offered to other persons who do not use the image forming apparatus. Hence, it is difficult to offer the advertisement effectively.

Moreover, in the technology disclosed in Japanese Laid-Open Patent Publication No. 2008-276437, the advertisements corresponding to the jobs previously performed by a user of the image forming apparatus may be displayed. However, the advertisements may not be effectively offered to other persons who may become potential customers.

### SUMMARY OF THE INVENTION

In one aspect, the present invention provides a content provision system which provides content, such as an advertisement, effectively and efficiently using use history of a user's electronic device.

In an embodiment which solves or reduces one or more of the above-described problems, the present invention provides a content provision system including an electronic device and a management system including one or more devices to manage content that is provided to a user through the electronic device, wherein the electronic device includes a detection unit configured to detect a user who has used the electronic device and to receive user identification information that identifies the user, and a transmission unit configured to transmit the user identification information received by the detection unit to the management system, and the management system includes a history management unit configured to manage history information which associates the user identification information transmitted by the transmission unit with the electronic device in which the user is detected by the detection unit, and a determination unit configured to determine the electronic device to distribute the content, and the user as an object of provision of the content based on content attributes indicating the object of provision of the content and the history information managed by the history management unit.

Other objects, features and advantages of the present invention will become more apparent from the following detailed description when read in conjunction with the accompanying drawings.

### BRIEF DESCRIPTION OF THE DRAWINGS

FIG. 1 is a diagram showing a system configuration of a content provision system according to an embodiment.

FIG. 2 is a diagram showing a hardware configuration of an MFP according to an embodiment.

FIG. 3 is a diagram showing a hardware configuration of a mobile terminal according to an embodiment.

FIG. 4 is a diagram showing a hardware configuration of a member information management server according to an embodiment.

FIG. 5 is a diagram showing a functional configuration of the content provision system according to the embodiment.

FIG. 6 is a diagram showing an example of an MFP information registration screen.

FIG. 7 is a diagram showing an example of information stored in a received DM storage unit of the MFP according to the embodiment.

FIG. 8 is a diagram showing an example of information stored in a member information storage unit of the member information management server according to the embodiment.

FIG. 9 is a diagram showing an example of a member information registration screen.

FIG. 10 is a diagram showing an example of information stored in a history information storage unit of an MFP management server.

FIG. 11 is a diagram showing an example of a direct mail submission screen.

FIG. 12 is a diagram showing an example of information stored in a DM information storage unit of a DM management server.

FIG. 13 is a diagram showing an example of an entrepreneur registration screen.

FIG. 14 is a sequence diagram for explaining a process in which a DM message is distributed to the MFP after DM submission in the content provision system according to the embodiment.

FIG. 15 is a sequence diagram for explaining a process in which the use history of the MFP is updated in the content provision system according to the embodiment.

FIG. 16 is a flowchart for explaining a DM printing process performed when the mobile terminal in the vicinity of the MFP is detected.

FIGS. 17A and 17B are diagrams showing a DM printing execution screen and so on.

FIGS. 18A, 18B and 18C are diagrams showing a DM list screen and so on.

FIG. 19 is a flowchart for explaining a DM printing process performed when the MFP is used by the user.

FIG. 20 is a diagram showing an example of a login screen.

FIG. 21 is a flowchart for explaining a DM count control process performed by the DM management server.

### DETAILED DESCRIPTION OF THE PREFERRED EMBODIMENTS

A description will be given of embodiments with reference to the accompanying drawings.

### System Configuration

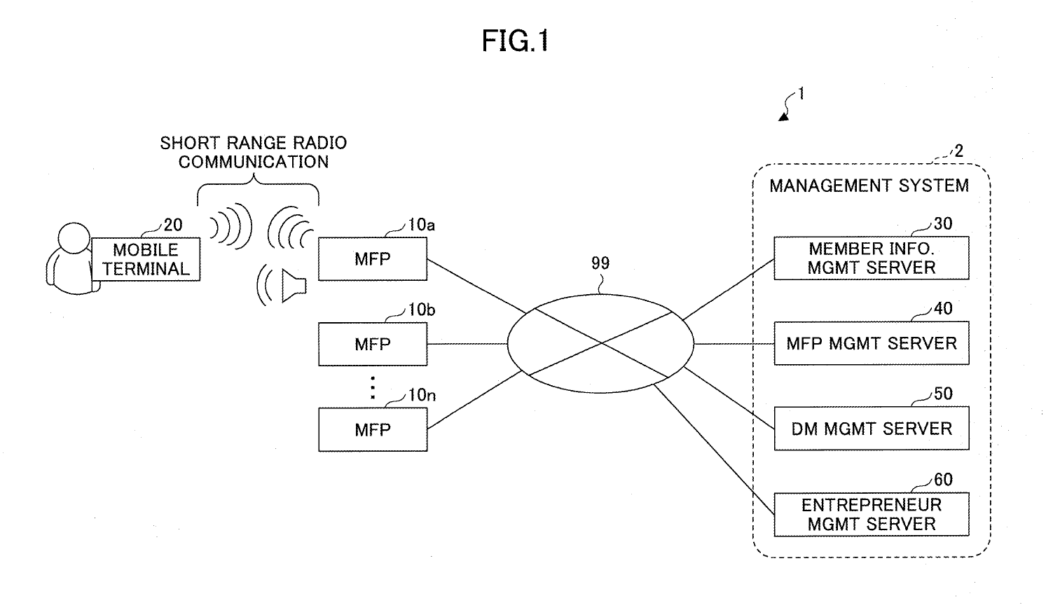

FIG. 1 is a diagram showing a system configuration of a content provision system 1 according to an embodiment. As shown in FIG. 1, the content provision system 1 includes MFPs (multifunction peripherals) 10a, 10b, 10n (which will be collectively called “MFP 10” unless otherwise specified), a mobile terminal 20, a member information management server 30, an MFP management server 40, a DM (direct mail) management server 50, and an entrepreneur management server 60.

The MFP 10 and the mobile terminal 20 have a function of performing short range radio communication. Hence, the MFP 10 and the mobile terminal 20 are configured to establish short range radio communication with each other. The short range radio communication is performed in conformity with the near field communication (NFC) standard requirements using frequencies in 13.56 MHz band based on ISO/IEC18092 or ISO/IEC21481 recommendations (which will be called “NFC communication”).

The short range radio communication may include not only the NFC communication but also the Bluetooth® communication.

The MFP 10, the member information management server 30, the MFP management server 40, the DM management server 50, and the entrepreneur management server 60 are interconnected by a wired or wireless network 99, such as the Internet. In addition, the member information management server 30, the MFP management server 40, the DM management server 50, and the entrepreneur management server 60 are included in a management system 2 which manages a variety of information items.

The MFP 10 is an example of an electronic device according to the invention. The MFP 10 is a multifunction peripheral (image forming apparatus) which performs two or more functions including a printer function, a scanner function, a copier function, a facsimile function, etc. in a single housing of the peripheral. Alternatively, an image forming apparatus which performs any one of the functions alone may be used as the MFP 10.

Moreover, the MFP 10 includes an NFC unit which performs the NFC communication. This NFC unit includes a rechargeable battery. When no electric power is supplied from a power supply of a main part of the MFP 10, the NFC unit is able to operate solely by electric power supplied from this battery.

Alternatively, the MFP 10 according to the embodiment may be another electronic device, such as an image processing apparatus with a projector or a large screen display.

When a function of the MFP 10 is used by a user or when a user's mobile terminal in a vicinity of the MFP 10 is detected, the MFP 10 according to the embodiment transmits information of use history of the MFP 10 by the user or use history of the MFP 10 by the detected mobile terminal (history information) to the MPF management server 40. In addition, the MFP 10 according to the embodiment is used in a case where the MFP function is used by a user and in a case where the user's mobile terminal in the vicinity of the MFP 10 is detected.

Moreover, when a DM (direct mail) message addressed to a user is detected and stored in the MFP 10, the MFP 10 notifies the user of the presence of the DM message by a speaker or the like included in the MFP 10.

The mobile terminal 20 is an example of a mobile medium carried by a user. The mobile terminal 20 may be an NFC-compliant device which is in conformity with the NFC communication standards, such as an IC card on which an NFC-compliant chip is mounted, a smart phone, a tablet terminal, a notebook PC, or a mobile phone. In addition, when the Bluetooth communication is used as the short range radio communication between the mobile terminal 20 and the MFP 10, a Bluetooth compliant device is mounted on the mobile terminal 20. Moreover, the mobile terminal 20 includes an IC chip in which a member ID which is user identification information to identify a user is stored.

The member information management server 30 is a computer in which user information, such as user identification information (member ID), a user name, a password, etc., and user attribute information are stored. The member information management server 30 may be implemented by a storage device (file server) connected to the network 99, such as NAS (network attached storage).

The MFP management server 40 is a computer which stores history information relating to the use of the MFP 10 by the user, information relating to the installation location of the MFP 10, etc. The MFP management server 40 may be implemented by NAS or the like.

The DM management server 50 is a computer in which direct mail (DM) messages which are digital contents, such as advertisements provided to users, are stored and managed. The DM management server 50 may be implemented by NAS or the like.

The entrepreneur management server 60 is a computer which manages entrepreneurs to distribute DM and accounting information to the entrepreneurs. The entrepreneur management server 60 may be implemented by NAS or the like.

The content provision system 1 according to the embodiment accumulates history information relating to the user who used the MFP 10 and relating to the user's mobile terminal detected in a predetermined range (for example, less than 5 m) of the MFP 10 by using the MFP 10. The content provision system 1 determines the MFP 10 to distribute the DM and the users to which the DM is to be provided by the MFP 10 based on DM attribute information indicating a target of the DM provision, and the history information. When the DM message which is addressed to the user who used the MFP 10 (or the user who carried the mobile terminal 20 detected in the vicinity of the MFP 10) is stored in the MFP 10, the MFP 10 notifies the user of the presence of the DM message by sound. The user is able to print the DM message by using the MFP 10.

In addition, the member information management server 30, the MFP management server 40, the DM management server 50, and the entrepreneur management server 60, included in the management system 2, may be implemented by a single computer in which the respective functions of the servers are integrated. Alternatively, the respective functions of the servers may be distributed to one or more computers in which such functions are integrated.

### Hardware Configuration

### [Image Forming Apparatus]

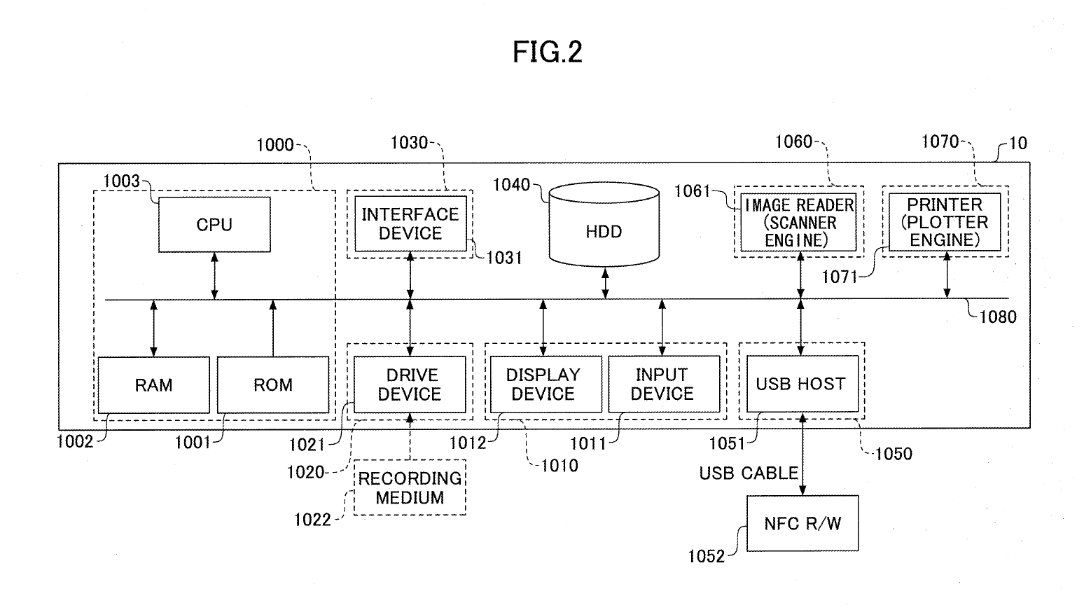

FIG. 2 is a diagram showing a hardware configuration of an MFP 10 according to an embodiment. The MFP 10 includes a controller 1000, an operation panel 1010, a recording medium interface 1020, a data communication interface 1030, a HDD (hard disk drive) 1040, an NFC interface 1050, a scanner 1060, and a plotter 1070, which are interconnected by a PCI bus 1080.

The controller 1000 includes a ROM (read-only memory) 1001, a RAM (random access memory) 1002, and a CPU (central processing unit) 1003. The ROM 1001 stores programs executed when the MFP 10 is initiated, and various data. The RAM 1002 temporarily stores various programs and data which are read from the ROM 1001 or the HDD 1040.

The operation panel 1010 includes an input device 1011 and a display device 1012. The input device 1011 includes hardware keys and others. The input device 1011 is used to input a manipulation signal to the MFP 10. The display device 1012 includes a display and displays a variety of information items relating to image formation operation, for example.

The recording medium interface 1020 includes a drive device 1021. When a recording medium 1022 is placed on the drive device 1021, various data recorded in the recording medium 1022 are stored into the HDD 1040 through the drive device 1021.

The data communication interface 1030 includes an interface device 1031 and provides an interface for connecting the MFP 10 to a data transmission line, such as the network 99.

The HDD 1040 stores various data including received document data, read image data, etc., handled by the MFP 10. In the HDD 1040, these various data are managed by a predetermined file system or a database (DB). For example, the various data stored in the HDD 1040 may include electronic data recorded by an external device, such as a smart phone or a digital camera. In such a case, the electronic data are provided to the MFP 10 by the recording medium 1022, such as an SD card, or uploaded to the MFP 10 through the network such as the data transmission line.

The NFC interface 1050 includes a USB (universal serial bus) host 1051. The USB host 1051 is connected to an NFC R/W (reader/writer) 1052 through a USB cable. The USB host 1051 has a function of controlling physical and electrical interfaces for communicating with the NFC R/W 1052, and a function of controlling the USB protocol. The USB host 1051 communicates with the NFC R/W 1052. Alternatively, the NFC R/W 1052 may be incorporated in the housing of the MFP 10.

The scanner 1060 includes an image reader 1061 (or a scanner engine). The image reader 1061 optically reads a document placed on a reading surface of the scanner and generates image data from the read image.

The plotter 1070 includes a printer 1071 (or a plotter engine). For example, the printer 1071 prints a bitmap image on a recording sheet by using an electrophotographic printing process.

In this manner, the MFP 10 performs multiple image formation functions including a copier function, a printer function, a facsimile function and a scanner function, an information retrieval function, a communication function including a short range radio communication function, an authentication function, etc., by using the above-described hardware configuration.

### [Mobile Terminal]

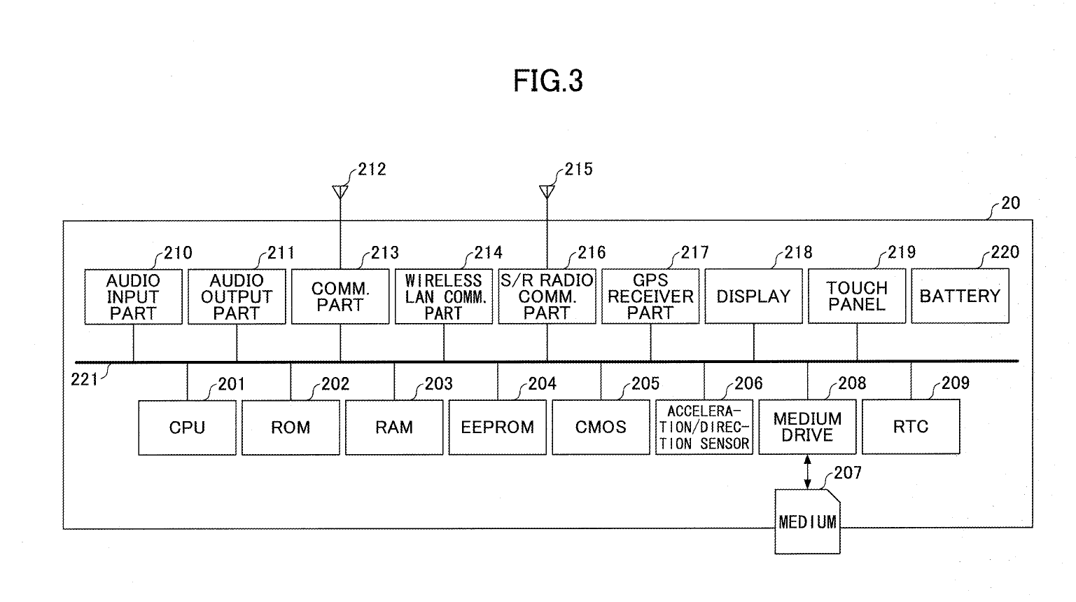

FIG. 3 is a diagram showing a hardware configuration of a mobile terminal 20 according to an embodiment. It is assumed that the mobile terminal 20 is an NFC-compliant mobile terminal, and the hardware configuration of the mobile terminal 20 is shown in FIG. 3.

The mobile terminal 20 includes a CPU 201, a ROM 202, a RAM 203, an EEPROM 204, a CMOS (complementary metal oxide semiconductor) sensor 205, an acceleration/direction sensor 206, a medium drive 208, and a RTC (real time clock) 209. The CPU 201 controls overall operation of the NFC-compliant mobile terminal 20. The ROM 202 stores basic input/output programs. The RAM 203 is used as a work area of the CPU 201. The EEPROM 204 is controlled by the CPU 201 to read data from or write data to the EEPROM 204. The CMOS sensor 205 is controlled by the CPU 201 to capture a light image of a subject and output image data. The acceleration/direction sensor 206 may include an acceleration sensor to detect an acceleration of the mobile terminal 20 and an electromagnetic compass or gyrocompass to detect earth magnetism. The medium drive 208 controls reading data from and writing (storing) data to a recording medium 207 such as a flash memory. The RTC 209 is an IC chip which outputs time information such as the current date/time. The recording medium 207 is detachably attached to the medium drive 208. According to the control of the medium drive 208, the data already recorded in the recording medium 207 are read out or new data are stored into the recording medium 207.

The EEPROM 204 stores an operating system (OS) executed by the CPU 201, association information required for the network setting, and data used for the authentication performed to allow a user to use the MFP 10. The CMOS sensor 205 may be a charge-coupled device which transforms light into an electric charge and electronically generates an image of a subject. Alternatively, the CMOS sensor 205 may be replaced by a CCD (charge coupled device) sensor as long as it is capable of capturing an image of a subject.

The mobile terminal 20 further includes an audio input part 210, an audio output part 211, an antenna 212, a communication part 213, a wireless LAN communication part 214, a short range radio communication antenna 215, a short range radio communication part 216, a GPS (global positioning system) receiver part 217, a display 218, a touch panel 219, and a battery 220. The above-described component parts 201-220 of the mobile terminal 20 are interconnected by a bus line 221 including an address bus and a data bus. The audio input part 210 transforms voice into an audio signal. The audio output part 211 transforms an audio signal into voice or sound. The communication part 213 uses the antenna 212 and communicates with a nearby base station using a wireless communication signal. The wireless LAN communication part 214 performs wireless LAN communication between the mobile terminal 20 and an access point in accordance with the requirements of IEEE 802.11 standard. The short range radio communication part 216 performs short range radio communication with the NFC R/W 1052 using the antenna 215. The GPS receiver part 217 receives a GPS signal from a GPS satellite. The display 218 is a liquid crystal display or an organic EL display to display an image of a subject and various icons. The touch panel 219 is mounted on the display 218 and formed by a pressure-sensitive or electrostatic panel. The touch panel 219 detects a touched position on the display 218 by a user's finger or a touch pen. The battery 220 is a dedicated battery for use in the mobile terminal 20, and the mobile terminal 20 is activated by the battery 220. The audio input part 210 includes a microphone to input voice. The audio output part 211 includes a loudspeaker to output voice or sound.

In this manner, the mobile terminal 20 performs basic mobile terminal functions, a terminal positioning function, a short range radio communication (NFC) function with the NFC R/W 1052, etc., by using the above-described hardware configuration. The communication between the mobile terminal 20 and the MFP 10 may include the short range radio communication (NFC) and the wireless LAN communication. However, the short range radio communication (NFC) is preferable to the wireless LAN communication from a viewpoint of reducing power consumption of the mobile terminal 20.

In addition, when it is desired to replace the mobile terminal 20 by an IC card as another example of a mobile medium carried by a user, the IC card may be arranged to incorporate the CPU 201, the ROM 202, the RAM 203, the EEPROM 204, the short range radio communication antenna 215, and the short range radio communication part 216 from among the above-mentioned component parts 201-220 into an IC chip in the IC card. The short range radio communication antenna 215 included in the IC card may be a coil to receive a magnetic field generated by the NFC R/W 1052, and the antenna 215 may supply electric power to the IC chip and perform data exchange between the short range radio communication part 216 and the NFC R/W 1052.

### [Member Information Management Server]

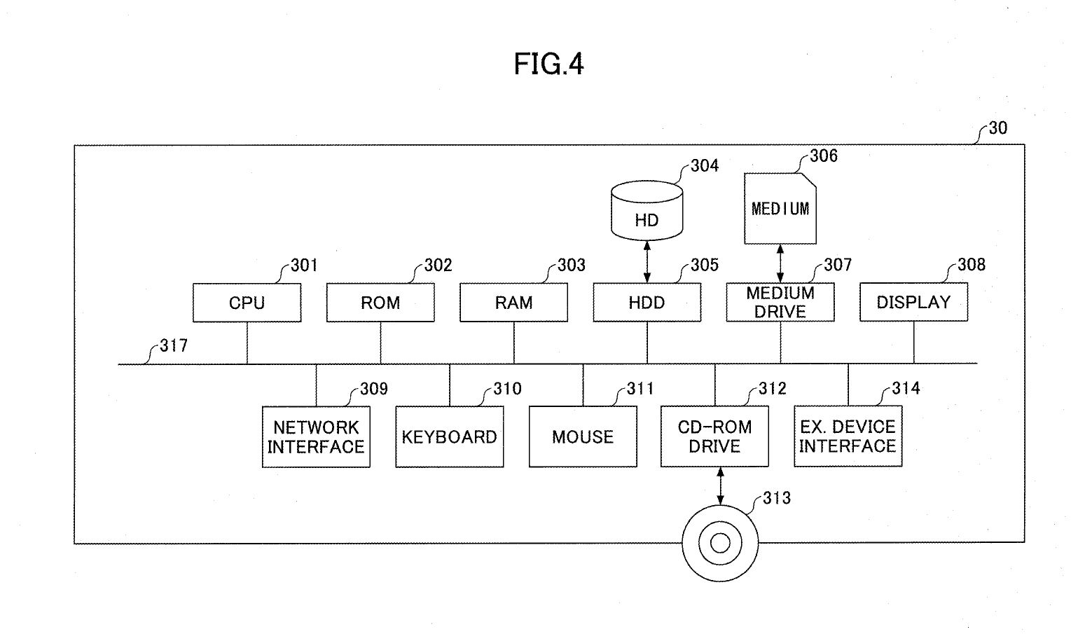

FIG. 4 is a diagram showing a hardware configuration of a member information management server 30 according to an embodiment. The member information management server 30 includes a CPU 301, a ROM 302, a RAM 303, a hard disk (HD) 304, a HDD 305, a recording medium 306, a medium drive 307, a display 308, a network interface 309, a keyboard 310, a mouse 311, a CD-ROM drive 312, a CD-ROM 313, and an external device interface 314. The CPU 301 controls overall operation of the member information management server 30. The ROM 302 stores programs used to activate the CPU 301, such as an IPL (initial program loader). The RAM 303 provides a work area of the CPU 301. The HD 304 stores programs for management of mobile terminals, and various data. The HDD 305 is controlled by the CPU 301 to read data from and write data to the HD 304. The medium drive 307 is controlled by the CPU 301 to read data from and write data the recording medium 306 such as a flash memory. The display 308 displays a variety of information items including a cursor, menus, windows, characters and images. The network interface 309 performs data communication using the network 99. The keyboard 310 includes a set of keys for inputting characters, numerical values and various instructions. The mouse 311 is used by a user to perform selection and execution of various instructions, selection of a processing object, movement of a cursor, etc. The CD-ROM 313 is an example of a recording medium detachably attached to the CD-ROM drive 312. The CD-ROM drive 312 is controlled by the CPU 301 to read data from and write data to the recording medium. The external device interface 314 is used to connect an external device to the member information management server 30. The above-described component parts 301-314 of the member information management server 30 are interconnected by a bus line 317 including an address bus and a data bus.

In this manner, the member information management server 30 performs a communication function with the MFP 10 and an information storage function by using the above-described hardware configuration.

Each of the MFP management server 40, the DM management server 50, and the entrepreneur management server 60 in the content provision system 1 according to the embodiment may be arranged to have a hardware configuration which is the same as that of the member information management server 30.

### Functional Configuration

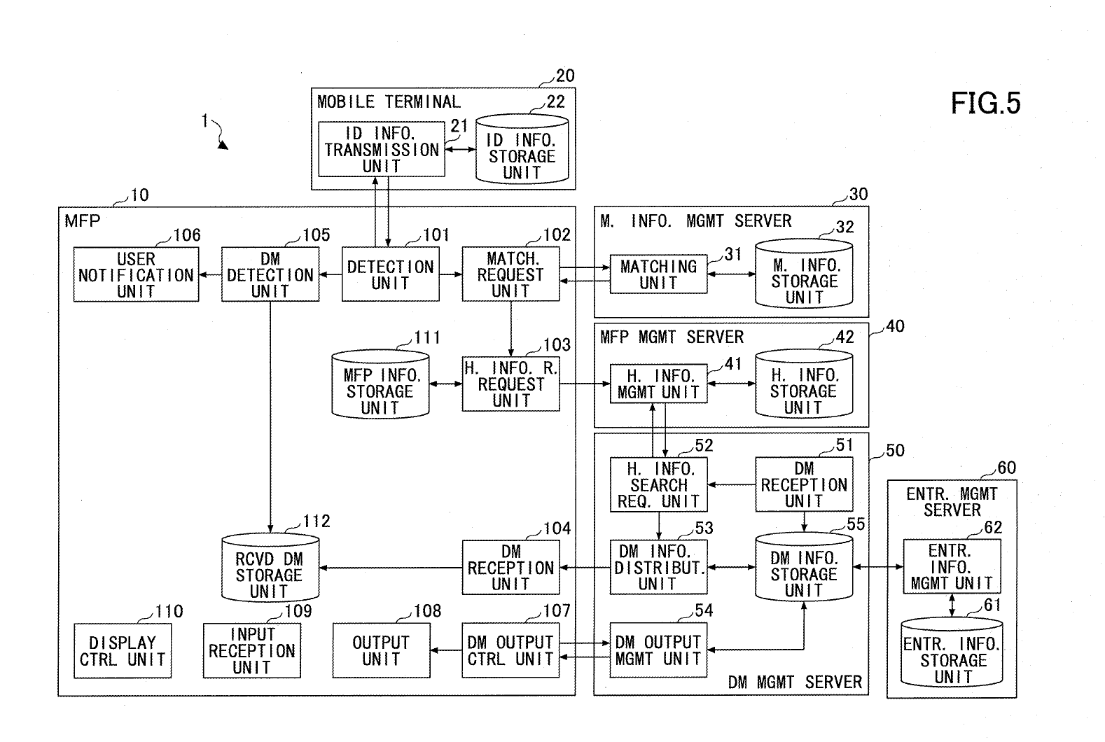

FIG. 5 is a diagram showing a functional configuration of the content provision system 1 according to the embodiment.

### [MFP]

The MFP 10 includes a detection unit 101, a matching request unit 102, a history information registration request unit 103, a DM reception unit 104, a DM detection unit 105, a user notification unit 106, a DM output control unit 107, an output unit 108, an input reception unit 109, a display control unit 110, an MFP information storage unit 111, and a received DM storage unit 112.

The detection unit 101 is activated when a communication process is started with the NFC R/W 1052. The detection unit 101 is configured to detect an NFC-compliant mobile terminal 20 in a vicinity of the MFP 10 (less than 5 m) using electromagnetic waves of a predetermined frequency band in conformity with the short range radio communication requirements of ISO/IEC18092 recommendations. Moreover, the detection unit 101 is configured to receive from the detected mobile terminal 20 a member ID which is identification information to uniquely identify a user, and output the member ID to the matching request unit 102. The distance at which the NFC communication is performed may be increased by changing the frequency band used. Furthermore, also when the MFP 10 is used by the user, the detection unit 101 is configured to output to the matching request unit 102 a member ID which is input by the user before using the MFP 10. Moreover, the detection unit 101 is configured to output the received member ID to the DM detection unit 105.

The matching request unit 102 is configured to generate a matching request including the member ID received from the detection unit 101, and transmit the matching request to the member information management server 30. Moreover, the matching request unit 102 is configured to receive user attribute information of the user (member) when a matching result as a response to the matching request indicates that a match of the member ID occurs. Furthermore, the matching request unit 102 is configured to send a history information update request to the history information registration request unit 103 when the matching result indicates that a match occurs.

The history information registration request unit 103 is configured to update history information based on the request from the detection unit 101. Specifically, the history information registration request unit 103 generates a history information registration request including the member ID and the user attribute information which are received from the detection unit 101, and transmits the generated history information registration request to the MFP management server 40.

The DM reception unit 104 is configured to receive DM information including a DM number, a DM name, member ID, a DM distribution period, a DM file body, and a preview image file, which are distributed from the DM management server 50, and store the DM information into the received DM storage unit 112.

The DM detection unit 105 is configured to determine whether a DM message which is suited to the member ID received from the detection unit 101 exists by making reference to the received DM storage unit 112. Moreover, when the DM message exists, the DM detection unit 105 is configured to cause the user notification unit 106 to notify the user that the DM message suited to the member ID exists.

The user notification unit 106 is configured to control a speaker or an external display (provided in the MFP 10) to output information indicating the presence of the DM message, by sound or an image, based on the instructions from the DM detection unit 105.

The DM output control unit 107 is configured to send to the DM management server 50 a DM reservation request for a process of DM printing, a print execution result, or a reserved DM release request. In other words, the DM output control unit 107 controls execution or cancellation of the DM printing so that a predetermined number of printable DM messages is not exceeded.

The output unit 108 is configured to control the printer 1071 to output a printout of the DM based on the instructions from the DM output control unit 107. The method of outputting a DM message is not limited to outputting a printout and may include, for example, displaying an image of a DM message on the display device 1012, such as the operation panel of the MFP, or an external display connected to the MFP.

The input reception unit 109 is configured to control the input device 1011 and receive the instructions input by the user on the input device 1011.

The display control unit 110 is configured to control the display device 1012 and display or output a variety of information items to the user.

The MFP information storage unit 111 is configured to store an MFP ID to identify the MPF 10 and MFP information to indicate an installation location of the MFP 10 into the HDD 1040 or the nonvolatile memory such as the ROM 1001. The MFP ID is an identifier that uniquely identifies the MFP 10. The MFP ID may be expressed by an arbitrary number, characters, symbols or a combination of them if it is unique. The MFP information to indicate the installation location of the MFP 10 may include a district code and an environment code. The district code included in the MFP information may include a prefecture code indicating a prefecture where the installation location of the MFP 10 is situated, and a city code indicating a city or town where the installation location of the MFP 10 is situated. The environment code is information that indicates attributes of the installation location of the MFP 10. For example, the environment code may be expressed by any of a convenience store, an apartment, etc.

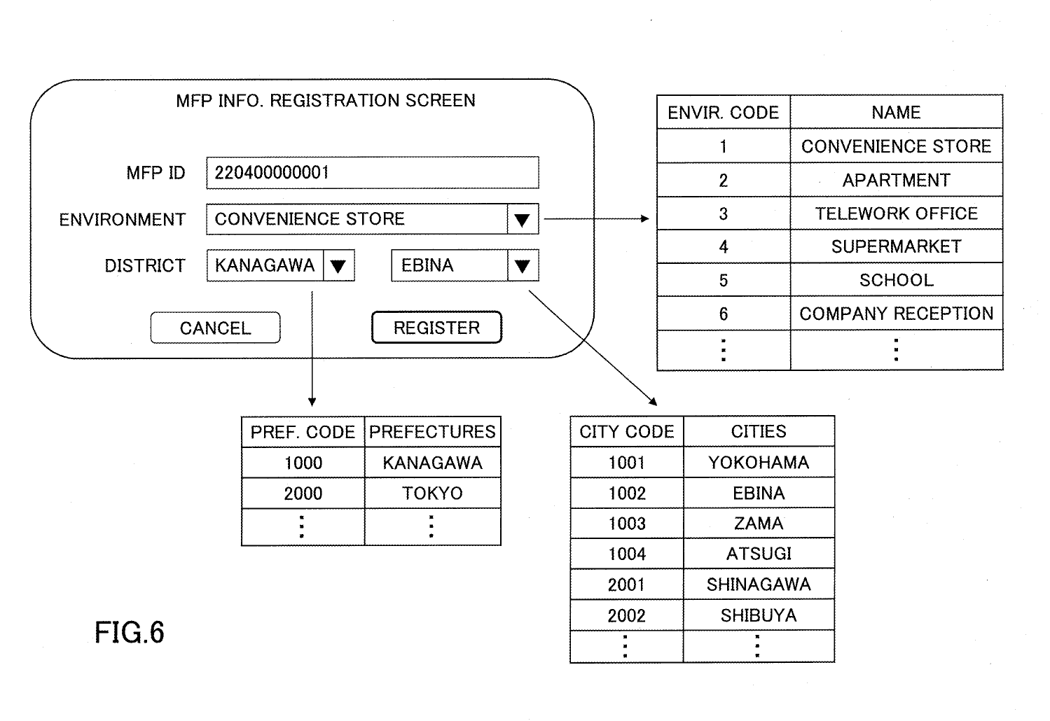

In addition, as shown in FIG. 6, the MFP information stored in the MFP information storage unit 111 is input based on an MFP information registration screen displayed on the operation panel 1010 of the MFP 10. FIG. 6 is a diagram showing an example of the MFP information registration screen. An administrator of the content provision system 1 operates the operation panel 1010 of the MFP 10 and inputs information relating to the installation location of the MFP 10 based on the MFP information registration screen as shown in FIG. 6. The input of the MFP information is not limited to the inputting of the MFP information by using the operation panel 1010 of the MFP 10. Alternatively, the MFP information may be input to the MFP 10 remotely from the MFP management server 40 so that the MFP information is registered in the MFP 10.

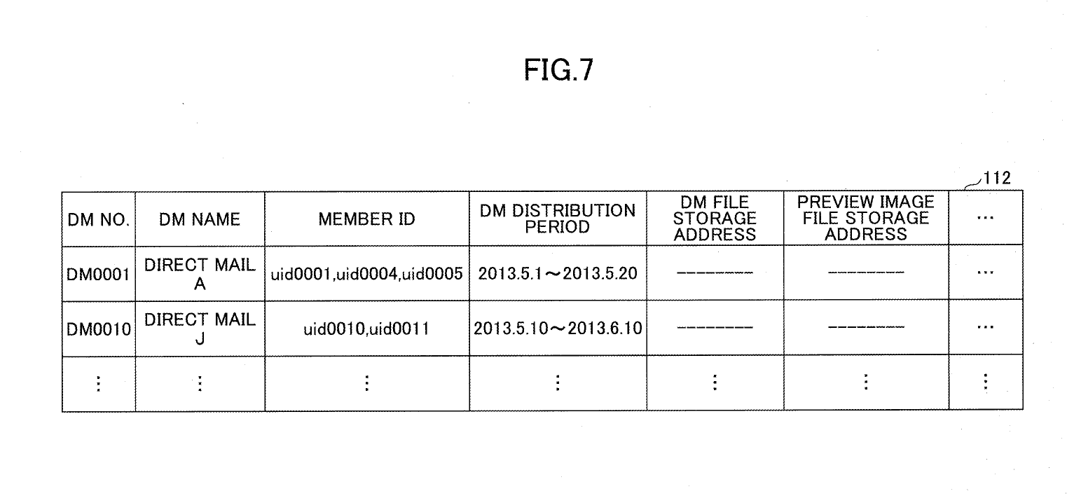

The received DM storage unit 112 is configured to store a DM message received by the DM reception unit 104 into the HDD 1040. FIG. 7 is a diagram showing an example of information stored in the received DM storage unit 112. As shown in FIG. 7, the DM reception unit 104 is configured to store a DM number to identify the DM message, a DM name indicating a name of the DM message, a DM distribution period assigned to an entrepreneur, a DM file storage address, a preview image file storage address, and a member ID indicating a member (user) who prints the DM message.

### [Mobile Terminal]

The mobile terminal 20 includes an identification information transmission unit 21 and an identification information storage unit 22.

When the mobile terminal 20 is detected by the MFP 10, the identification information transmission unit 21 is configured to receive a member ID (which is user identification information to identify the user) from the identification information storage unit 22 and transmit the member ID to the MFP 10 by short range radio communication. The identification information storage unit 22 is configured to store the member ID which is the user identification information into the EEPROM 204 or the medium 207.

### [Member Information Management Server]

The member information management server 30 includes a matching unit 31 and a member information storage unit 32.

The matching unit 31 is configured to determine, in response to a matching request received from the MFP 10, whether a member ID included in the matching request is stored in the member information storage unit 32 by making reference to the member information storage unit 32. When it is determined that the member ID included in the matching request is stored in the member information storage unit 32, the matching unit 31 is configured to receive user attribute information corresponding to the member ID included in the matching request from the member information storage unit 32, and transmit the user attribute information to the MFP 10 together with a matching result indicating a matching OK.

On the other hand, when it is determined that the member ID included in the matching request is not stored in the member information storage unit 32, the matching unit 31 is configured to transmit only a matching result indicating a matching NG (no good) to the MFP 10.

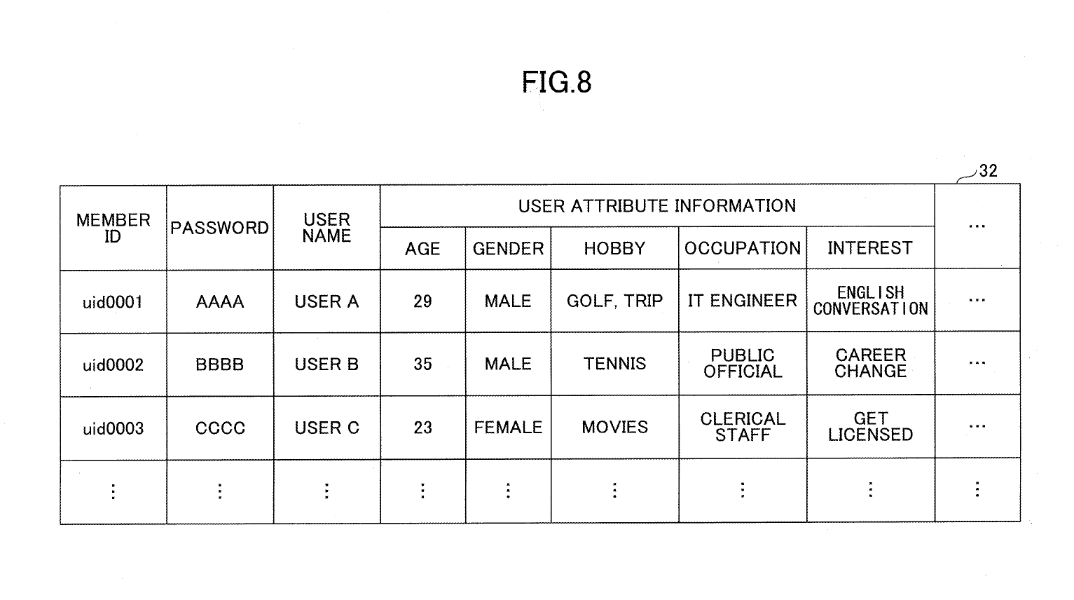

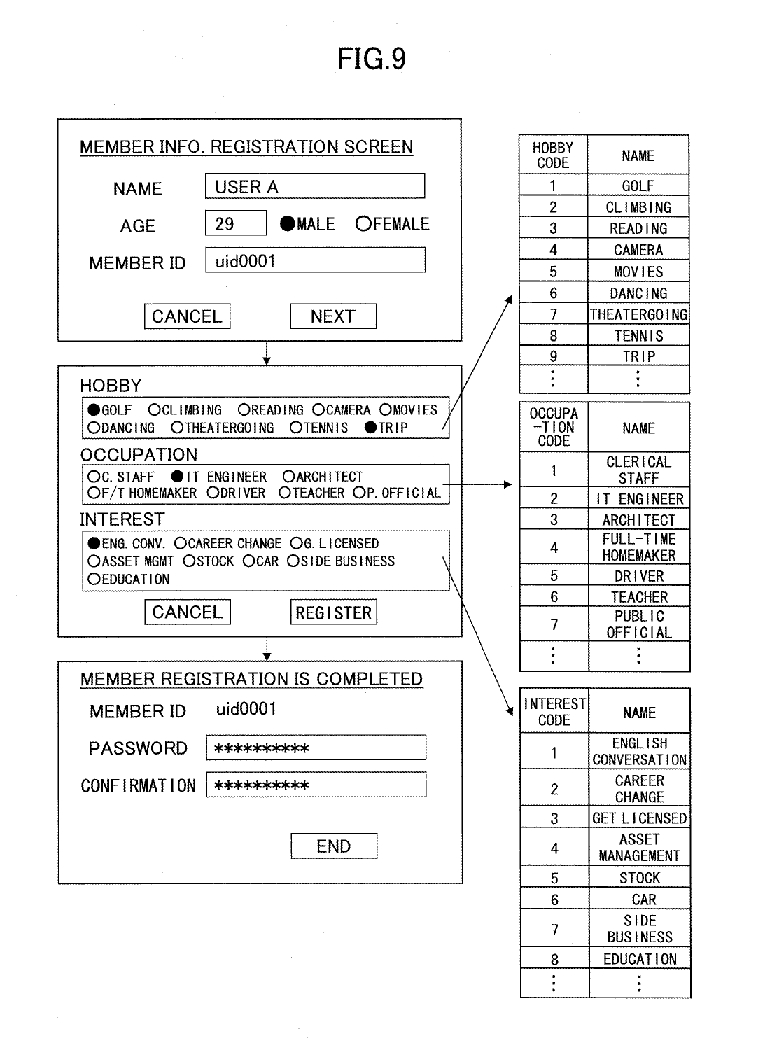

The member information storage unit 32 is configured to store member information relating to users (members) as shown in FIG. 8. FIG. 8 is a diagram showing an example of the member information stored in the member information storage unit 32. As shown in FIG. 8, the member information storage unit 32 stores data items of each user (each member), including a member ID, a password, a user name, and user attribute information. The member ID is user identification information to uniquely identify the user (member). The password and the user name are included in user information. The password and the user name may be arbitrarily set up. The user attribute information is attribute information of the user, including an age, a gender, a hobby and an occupation of the user. Alternatively, the member information storage unit 32 may be configured to further store a mail address of the user. Furthermore, the information stored in the member information storage unit 32 may be input from a client terminal, such as a PC used by the user, through a web page of the member information registration screen as shown in FIG. 9. FIG. 9 is a diagram showing an example of the member information registration screen according to this embodiment.

### [MFP Management Server]

The MFP management server 40 includes a history information management unit 41 and a history information storage unit 42.

The history information management unit 41 is configured to manage history information indicating that the MFP 10 is used by a user, or indicating that a user's mobile terminal 20 in the vicinity of the MFP 10 is detected, using the history information storage unit 42.

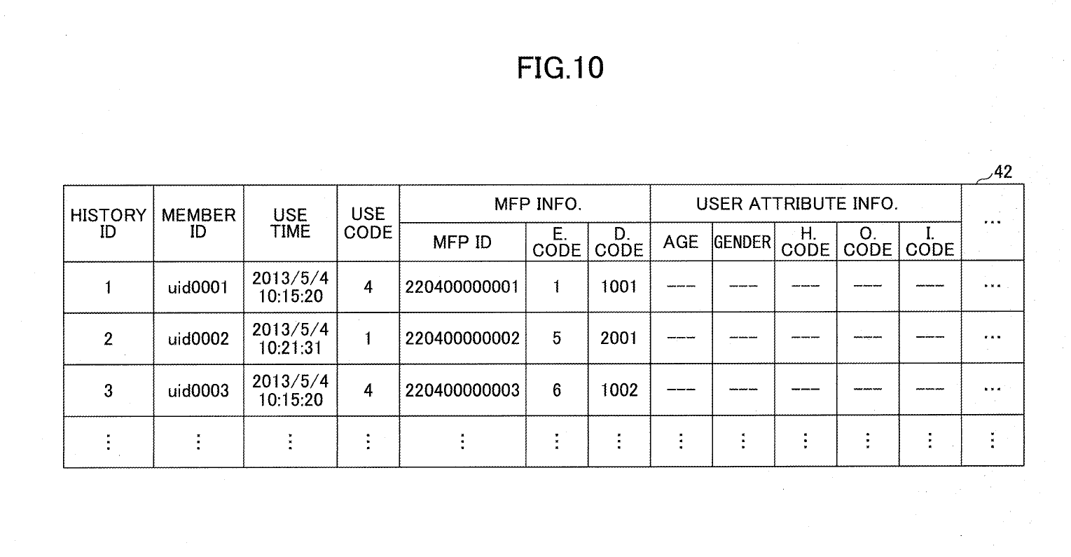

The history information storage unit 42 is configured to store the history information of the user (or the member) who has used the MFP 10, as shown in FIG. 10. FIG. 10 is a diagram showing an example of the history information stored in the history information storage unit 42. As shown in FIG. 10, the history information storage unit 42 stores data items which include a history ID, a member ID, a use time, a use code, MFP information, and user attribute information. The history ID is identification information to identify each history record. The member ID is a member ID of the user who used the MFP 10, or whose mobile terminal in the vicinity of the MFP 10 was detected. The use time is a time when the MFP 10 was used by the user. The use code is information that indicates a use pattern of the MFP 10 and is set up such that a use code “1” indicates the use of the copying function of the MFP 10, a use code “2” indicates the use of the printing function of the MFP 10, a use code “3” indicates the use of the facsimile function of the MFP 10, and a use code “4” indicates the detection of a mobile terminal in the vicinity of the MFP 10. The MFP information is MFP information relating to the installation location of the MFP 10 used. The user attribute information is user attribute information of the user (or the member).

### [DM Management Server]

The DM management server 50 includes a DM submission reception unit 51, a history information search request unit 52, a DM information distribution unit 53, a DM output management unit 54, and a DM information storage unit 55.

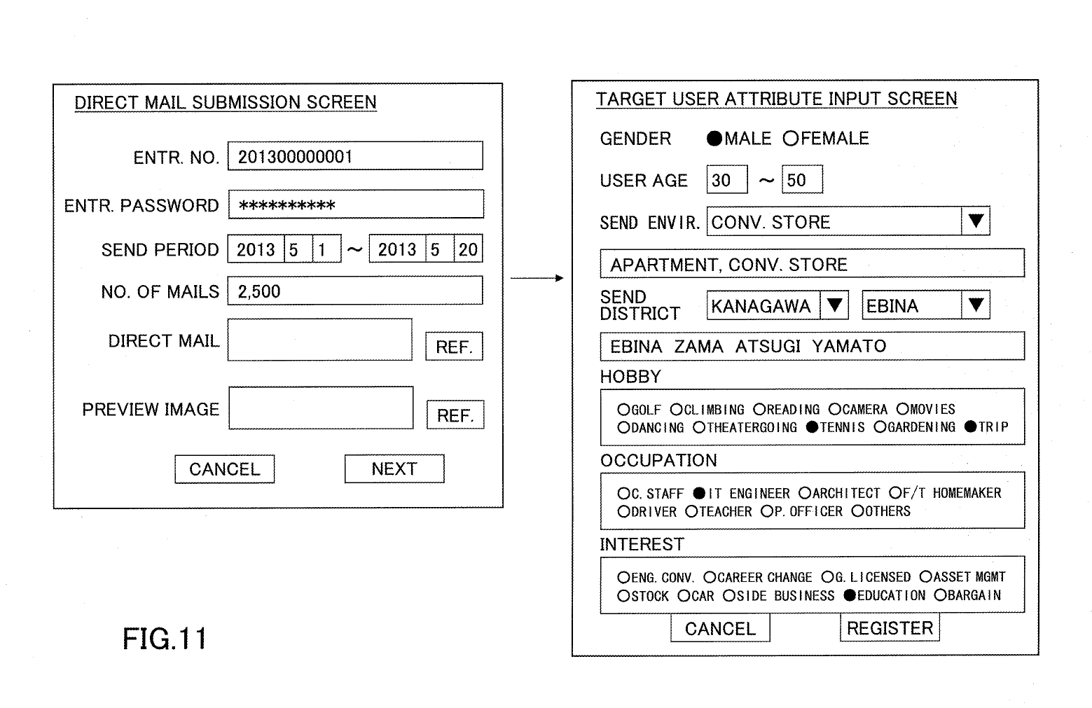

The DM submission reception unit 51 is configured to receive submission of a DM message from a PC (personal computer) of an entrepreneur through a web page of a direct mail submission screen. FIG. 11 is a diagram showing an example of the direct mail submission screen. When the entrepreneur inputs a URL (uniform resource locator) of the direct mail submission screen from a web browser of the PC, the DM submission reception unit 51 displays the direct mail submission screen as shown in FIG. 11. On the direct mail submission screen, the entrepreneur designates an entrepreneur number to uniquely identify the entrepreneur, an entrepreneur password, a send period of the DM, the number of mail messages sent (the number of copies printed by the MFP 10), a direct mail file (mail body) created in a format (e.g., PDF) that can be printed by the MFP 10, and a preview image file created in a format (e.g., JPEG) which can be displayed on the operation panel 1010 of the MFP 10. After a “next” button is pressed the direct mail submission screen changes to a target user attribute input screen as shown in FIG. 11. On the target user attribute input screen, the entrepreneur inputs attribute information of target users to which the direct mail messages are distributed. If a “register” button is depressed after the inputting of the target user attribute information is completed, the DM submission reception unit 51 assigns a DM number for identifying the DM message to the registered DM, and stores the DM number in the DM information storage unit 55.

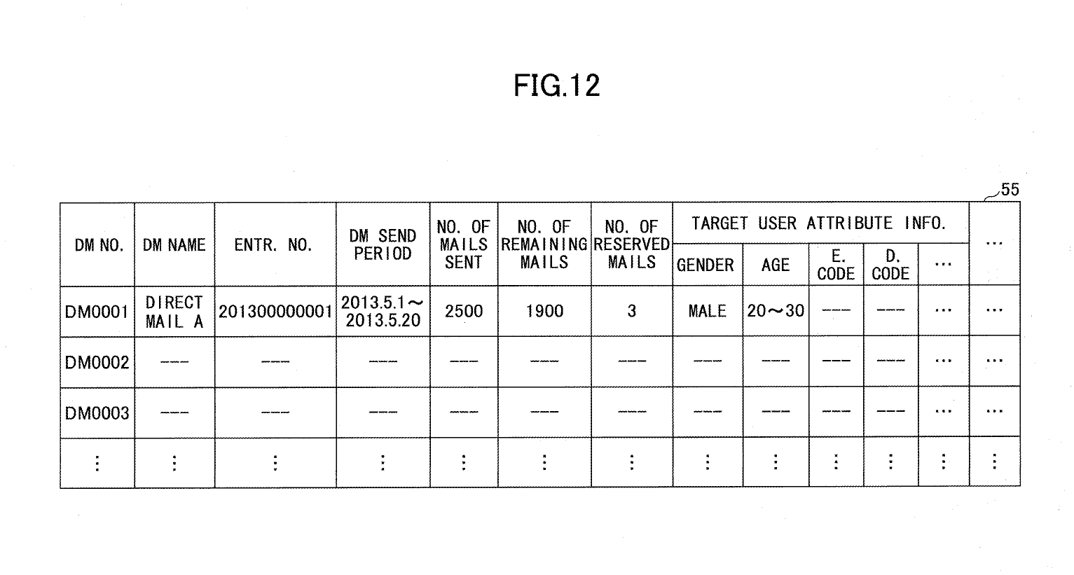

The DM information storage unit 55 stores information relating to attributes (content attributes) of the DM message indicating the object of provision of the DM message submitted by an entrepreneur, as shown in FIG. 12. FIG. 12 is a diagram showing an example of the information stored in the DM information storage unit 55 of the DM management server 50. As shown in FIG. 12, the DM information storage unit 55 stores data items which include a DM number, a DM name, an entrepreneur number, a DM send period, the number of mail messages to be sent, the number of remaining mail messages, the number of reserved mail messages, and target user attribute information. The DM number is identification information to uniquely identify the DM message. The DM name is a name of the DM message. The DM name may be set up arbitrarily by the entrepreneur. The entrepreneur number is identification information to identify the entrepreneur who submitted the DM message. The DM send period is a period for which the DM is sent. The number of mail messages to be sent is the number of direct mail messages to be sent (or the number of copies printed by the MFP 10). The number of mail messages to be sent may be determined based on the amount billed by the entrepreneur. The number of remaining mail messages is a difference between the number of mail messages to be sent and the number of mail messages actually sent (printed). Whenever the DM is printed, the number of remaining mail messages is decremented. The number of reserved mail messages is the number of mail messages for which printing of the DM message is not performed but a reservation request from the MFP 10 was sent when the printing is executed as scheduled. The target user attribute information is information relating to attributes of target users to which the DM message is sent input by the entrepreneur.

The history information search request unit 52 is configured to generate a history information search request including the target user attribute information of the DM message submitted by the entrepreneur, in order to specify the MFP 10 used to distribute the DM, and transmit the history information search request to the MFP management server 40. As a response to the history information search request, the history information search request unit 52 receives an MFP number and a member ID of the MFP 10 used as the distribution target of the DM message, and outputs the MFP number and the member ID to the DM information distribution unit 53.

The DM information distribution unit 53 is configured to transmit DM information including the DM number, the DM name and the member ID to the MPF 10 of the MFP number included in the history information received from the history information search request unit 52.

The DM output management unit 54 is configured to update the number of the remaining mail messages by making reference to the DM information storage unit 55, or update the number of reserved mail messages when the printing of the DM messages is executed as scheduled.

### [Entrepreneur Management Server]

The entrepreneur management server 60 includes an entrepreneur information control unit 61 and an entrepreneur information storage unit 62.

The entrepreneur information control unit 61 is configured to manage information necessary to an entrepreneur for distributing the DM and for submitting the DM using the content provision system 1, by using the entrepreneur information storage unit 62.

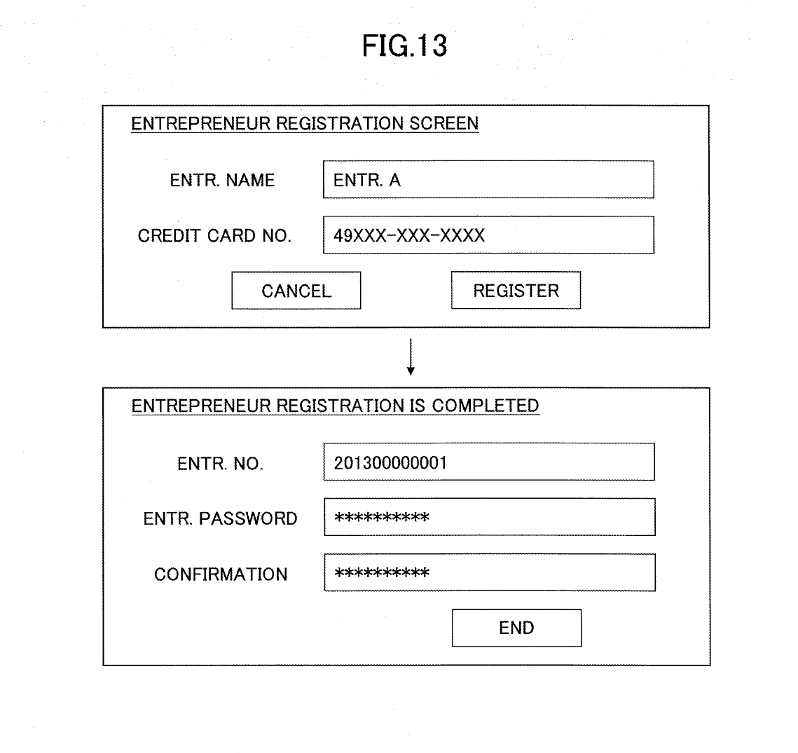

The information stored in the entrepreneur information storage unit 62 includes an entrepreneur name, a credit card number for payment of DM distribution, an entrepreneur number, and an entrepreneur password. The entrepreneur displays an entrepreneur registration screen as shown in FIG. 13 by inputting a URL of the entrepreneur registration screen from the web browser of the PC of the entrepreneur, and inputs the entrepreneur information from the entrepreneur registration screen.

In the following, it is assumed that in the content provision system 1 according to the embodiment, the process of entrepreneur registration is carried out beforehand.

### [Operation of Content Provision System]

In the following, (1) a DM distribution process, (2) a use history updating process, and (3) a DM printing process, which are performed by the content provision system 1 according to the embodiment, will be described.

### (1) DM Distribution Process

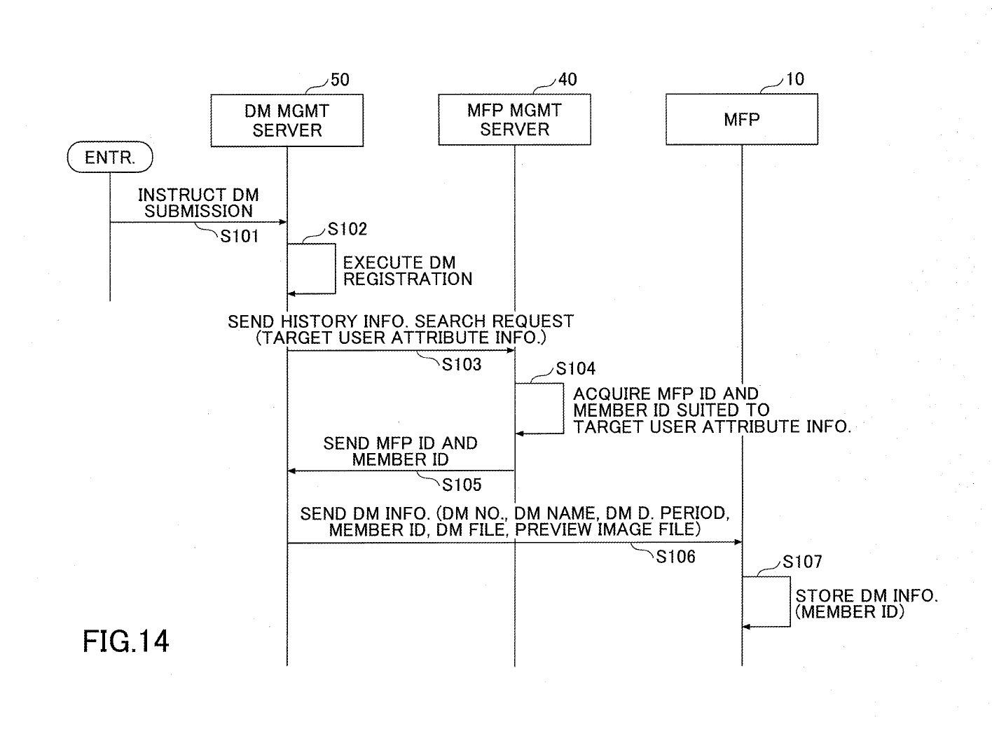

FIG. 14 is a sequence diagram for explaining a process in which a DM message submitted by an entrepreneur is distributed to the MFP 10 in the content provision system 1 according to the embodiment. It is assumed that in an initial state of the content provision system 1 prior to a start of the process of FIG. 14, the entrepreneur is registered beforehand by the entrepreneur based on the entrepreneur registration screen (FIG. 13).

As shown in FIG. 14, the entrepreneur orders the DM submission by selecting the file of the DM message submitted and inputting the predetermined information based on the direct mail submission screen (FIG. 11) displayed through the web browser of the entrepreneur's PC (S101).

When the DM submission reception unit 51 of the DM management server 50 receives the order of the DM message submission from the entrepreneur based on the direct mail submission screen, the DM management server 50 registers the information relating to the DM message submission in the DM information storage unit 55 (S102). Subsequently, the DM submission reception unit 51 outputs the target user attribute information of the DM message submission to the history information search request unit 52. Subsequently, the history information search request unit 52 generates a history information search request including the target user attribute information, and transmits the generated history information search request to the MFP management server 40 (S103).

When the history information search request is received, the history information management unit 41 of the MFP management server 40 receives the member ID corresponding to the MFP information (the environment code, the district code) and the user attribute information suited to the target user attribute information included in the history information search request, by making reference to the history information storage unit 42 (FIG. 10). In this case, it is determined that the MFP information and the user attribute information are suited to the target user attribute information, when more than a predetermined number of items among the user attribute information and the MFP information included in the history information management unit 41 are in agreement. The history information management unit 41 receives the MFP ID of the MFP 10 to distribute the DM message and the member ID by the suitability determination process (S104). Subsequently, the history information management unit 41 transmits the MFP ID and the member ID to the DM management server 50 as a response to the history information search request (S105).

The history information search request unit 52 of the DM management server 50 sends a notification including the MFP ID and the member ID received from the MFP management server 40, to the DM information distribution unit 53. The DM information distribution unit 53 receives the DM number of the DM message submitted at step S101, the DM name, and the DM distribution period from the DM information storage unit 55, and transmits, to the MFP 10 with the MFP ID, DM information including the DM number, the DM name, the DM distribution period, the DM file body, the preview image, and the member ID (S106).

Upon reception of the DM information from the DM management server 50, the DM reception unit 104 of the MFP 10 stores the received DM information into the received DM storage unit 112 (FIG. 7) (S107).

By performing the above-described process, the content provision system 1 stores the DM information of the DM message submitted by the entrepreneur into the MFP 10 which is specified based on the attributes of the target user to which the DM message is sent and the history information (the user attribute information) indicating that the MFP 10 was used in the past. In this manner, the MFP 10 stores the information which associates the user (the member) as a distribution target of the DM message with the DM message. When a DM message for the user who used the MFP 10 (such as the copying function) or whose mobile terminal in the vicinity of the MFP 10 is detected, the user may be notified of the presence of the DM message.

### (2) Use History Updating Process

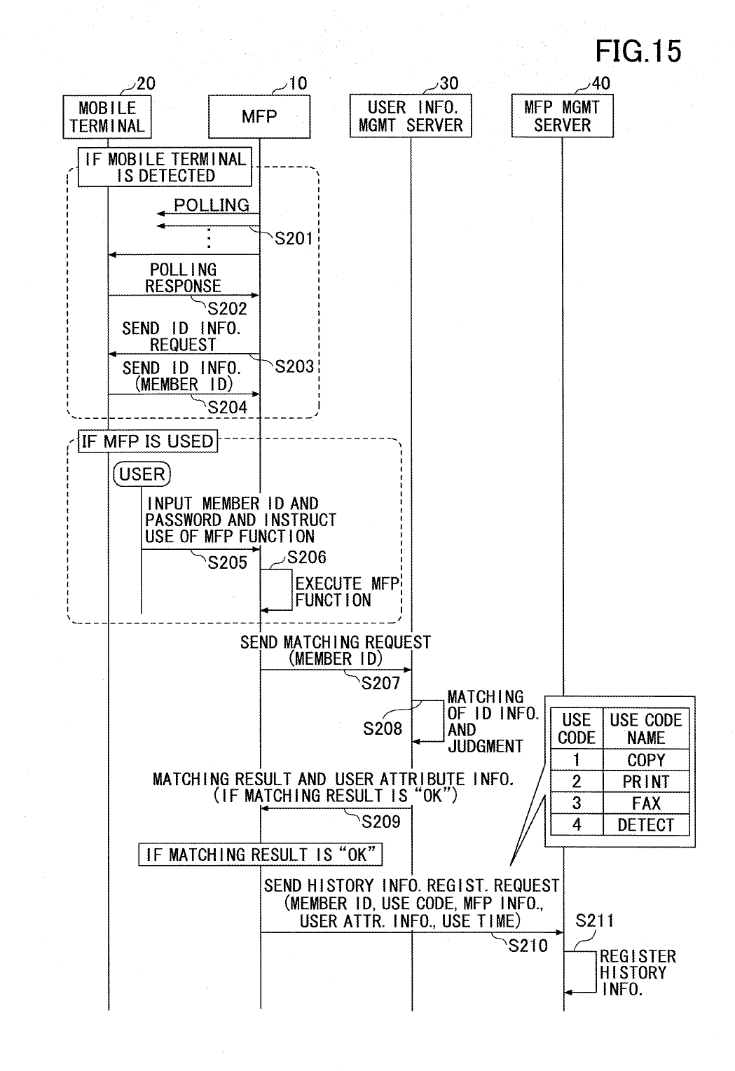

Next, a use history updating process in which the MFP management server 40 stores use history relating to a user who used the MFP 10 (such as the copying function) or whose mobile terminal was in the vicinity of the MFP 10 will be described with reference to FIG. 15.

FIG. 15 is a sequence diagram for explaining a process in which the use history of the MFP 10 is updated in the content provision system 1 according to the embodiment.

First, operation of the content provision system 1 in a case in which the mobile terminal 20 is detected by the MFP 10 by short range radio communication, which is one of the opportunities for updating the use history, will be explained. To catch an NFC-compliant device (the mobile terminal 20) in the vicinity of the MFP 10, the detection unit 101 of the MFP 10 performs polling (monitoring) at intervals of a predetermined period (for example, 1 second) (S201).

If the mobile terminal 20 is located in a range (about 5 m distant from the MFP 10) in which the polling can be received, the identification information transmission unit 21 of the mobile terminal 20 receives the polling. Upon reception of the polling, the identification information transmission unit 21 transmits a polling response to the MFP 10 (S202). The polling response includes identification information to uniquely identify the mobile terminal 20 (for example, a manufacture ID which is a combination of a manufacturer code of an NFC-compliant chip and identification information assigned to the NFC-compliant chip). Upon reception of the polling response, the MFP 10 is ready for performing the NFC communication in which the mobile terminal 20 having the identification information is specified, by setting the identification information of the mobile terminal 20 included in the polling response to a parameter of an NFC communication command.

After the polling response is received, the detection unit 101 of the MFP 10 transmits an identification information request to the mobile terminal 20 in order to receive a member ID which is the user identification information stored in the mobile terminal 20 (S203).

When the identification information request is received from the MFP 10, the identification information transmission unit 21 of the mobile terminal 20 reads out a member ID which is the user identification information stored in the identification information storage unit 22, and transmits the member ID to the MFP 10 (S204).

Next, operation of the content provision system 1 in a case in which an image formation function of the MFP 10 is used, which is another opportunity for updating the use history, will be explained.

On a login screen displayed on the operation panel 1010 of the MFP 10, a user inputs a member ID and a password (S205), and performs the image formation process (for example, the copying process) (S206). Alternatively, this step S206 may be performed after step S209 which will be described below is performed.

After the step S204 or the step S206 is performed, the matching request unit 102 of the MFP 10 generates a matching request including the member ID and the password (the password is included in the matching request only when the password is input by the user on the login screen in step S205 or the password is received in the step S204). The inclusion of the password in the matching request may be optional. The matching request unit 102 transmits the matching request to the member information management server 30 (S207).

The matching unit 31 of the member information management server 30 determines whether the member ID included in the matching request is stored in the member information storage unit 32 (FIG. 8) (S208). When the member ID included in the matching request is stored in the member information storage unit 32, the matching unit 31 determines that the member ID is registered (matching judgment OK). Moreover, the matching unit 31 transmits, to the MFP 10, the matching result and the user attribute information corresponding to the member ID in the case of the matching judgment OK (S209).

When the matching result includes the information indicating the matching judgment OK after the matching result is received by the matching request unit 102 of the MFP 10, the history information update request unit 103 generates a history information registration request including the member ID, the use code, the MFP information, the user attribute information, and the use time, and transmits the history information registration request to the MFP management server 40 (S210). Here, the use code is set up such that the use code “1” indicates the use of the copying function of the MFP 10, the use code “2” indicates the use of the printing function of the MFP 10, the use code “3” indicates the use of the facsimile function of the MFP 10, and the use code “4” indicates the detection of a mobile terminal in the vicinity of the MFP 10.

On the other hand, when the matching result includes the information indicating the matching judgment NG, the member ID is wrong or not found in the member information storage unit 32. In this case, a message indicating that the member ID is wrong may be displayed on the operation panel 1010.

Upon reception of the history information registration request, the history information management unit 41 of the MFP management server 40 stores the member ID, the use code, the MFP information, the user attribute information, and the use time, included in the history information registration request, into the history information storage unit 42 (S211).

By performing the above-described process, the content provision system 1 enables the MFP management server 40 to manage the use history of the user who used the MFP 10 or whose mobile terminal in the vicinity of the MFP 10 was detected.

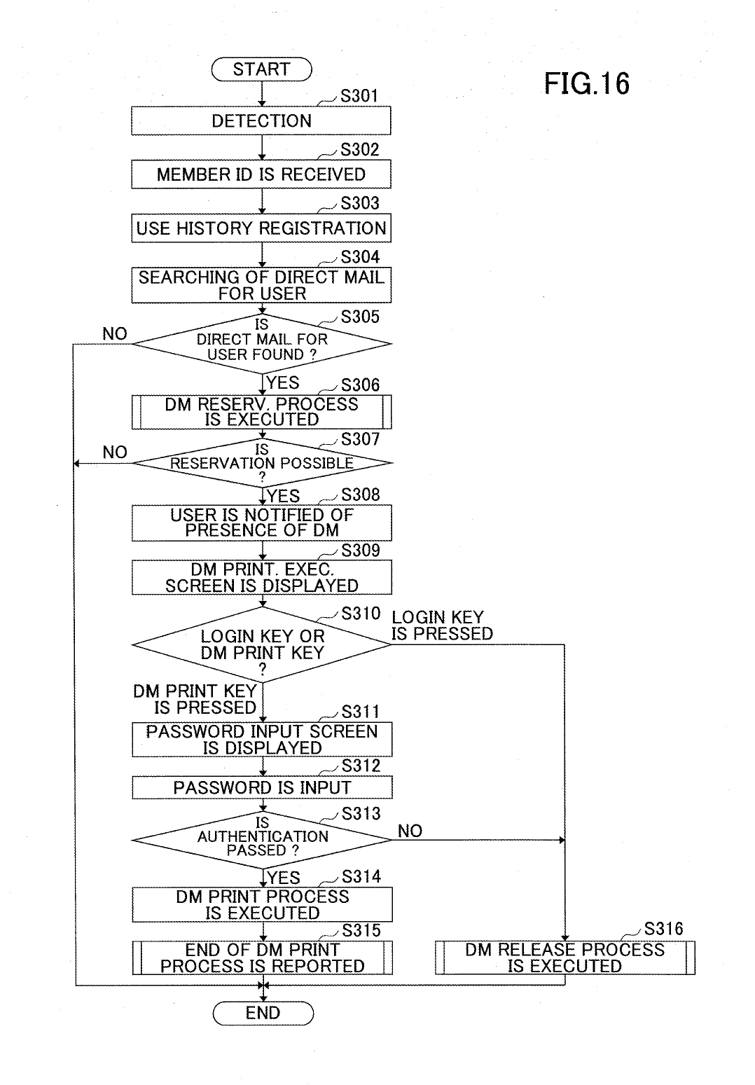

If a DM message for a user who logged in in the process of FIG. 16 (which will be described below) is detected in the MFP 10 after the step S209 is performed, a process in which the user is notified of the presence of the DM message will be performed.

### (3) DM Printing Process

Next, operation of the content provision system 1 in a case in which a DM message is printed will be explained.

### (3.1) Process of MFP

### (3.1.1) If Mobile Terminal is Detected by MFP

FIG. 16 is a flowchart for explaining a DM printing process performed when the mobile terminal 20 in the vicinity of the MFP 10 is detected.

First, the detection unit 101 of the MFP 10 detects the mobile terminal 20 located in a range of a predetermined distance (for example, less than 5 m) from the MFP 10 (S301). The detection unit 101 receives from the mobile terminal 20 a member ID which is the user identification information stored in the mobile terminal 20 (S302).

Subsequently, the use history updating process (see FIG. 15) is performed with respect to the received member ID (S303).

Moreover, the detection unit 101 sends a notification of the received member ID to the DM detection unit 105, so that the DM detection unit 105 searches for a DM message including the received member ID by making reference to the received DM storage unit 112 (FIG. 7) (S304).

When the DM message including the received member ID is detected in the received DM storage unit 112 (YES in step S305), a DM reservation process is performed by the DM management server 50 for the search-detected DM message (S306). The DM reservation process is performed in step order to reserve a DM message to be printed among the number of remaining mail messages in the DM information storage unit 55 (FIG. 12) of the DM management server 50. Then, it is determined whether the reservation is possible based on a result of the performance of the DM reservation process (S307).

When the reservation is possible (YES in step S307), the user notification unit 106 notifies the user (who owns the detected mobile terminal 20) of the presence of the DM message by sound by activating the speaker provided in the MFP 10 (S308). The method of notifying the user of the presence of the DM is not limited to the sound notification, and may include a method of displaying a message indicating the presence of the DM message on the operation panel 1010 or on a display device externally connected to the MFP 10. Alternatively, the sound notification and the display notification in combination may be used. Moreover, if the user registers an email address at a time of membership registration and the email address is stored in the member information storage unit 32, an email message indicating the presence of the DM message may be transmitted to the mobile terminal 20 by setting the email address to a destination address.

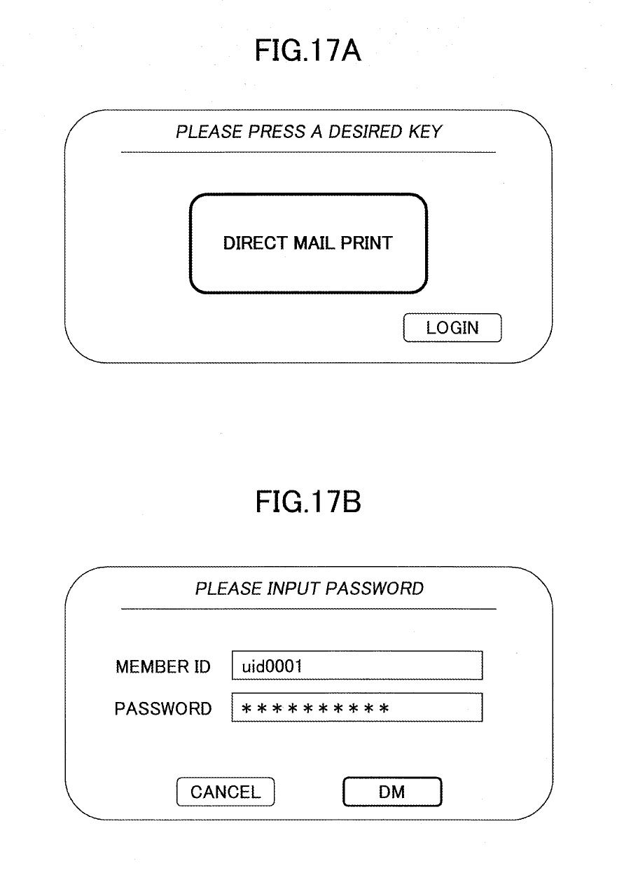

Subsequently, a DM printing execution screen as shown in FIG. 17A is displayed on the operation panel 1010 (S309). Then, it is determined whether a login key or a DM (direct mail) print key is pressed in the DM printing execution screen (S310).

When the DM print key is pressed, a password input screen as shown in FIG. 17B is displayed (S311). Subsequently, a password is input by the user in the password input screen (S312), and the matching request unit 102 sends an authentication request including the input password to the member information management server 30 (S313).

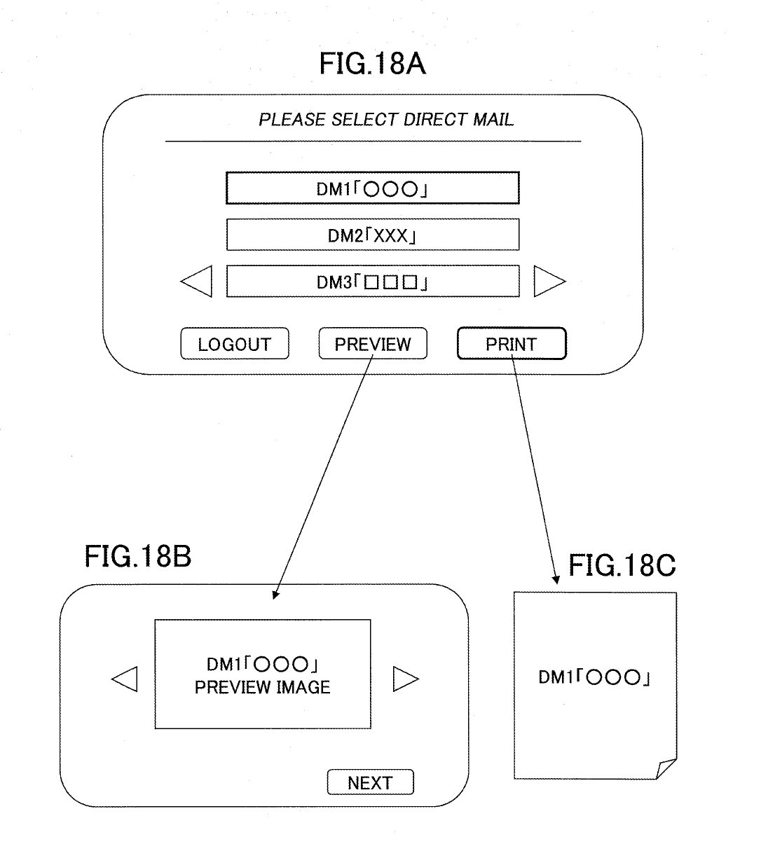

When the authentication is successfully performed (YES in step S313), the DM printing is performed (S314). In the DM printing process, a desired DM message of the DM messages in a DM list screen as shown in FIG. 18A displayed on the operation panel 1010 is selected. If a preview key is pressed after the desired DM message is selected, a preview image display screen as shown in FIG. 18B is displayed so that a preview image of the selected DM message is displayed on the operation panel 1010.

Moreover, if a print key in the DM list screen shown in FIG. 18A is pressed after the desired DM message is selected, the output unit 108 is controlled to perform the printing of the selected DM message as shown in FIG. 18C.

After the DM printing is performed, the DM output control unit 107 sends a notification of the end of the DM printing process to the DM management server 50 (S315).

On the other hand, when the login key in the DM printing execution screen is pressed in step S310, the screen changes to a normal MFP function screen in which the MFP function (copy, print, fax, etc.) may be selected, and the DM printing is not performed. Hence, a DM release request for releasing the DM reservation in the step S307 is transmitted to the DM management server 50 (S316).

In addition, when no DM message for the user exists (NO in step S305), or when the reservation of the DM message is not possible (NO in step S307), the process is terminated. For example, in this case, the normal MFP function screen may be displayed.

By performing the above-described process, the content provision system 1 notifies the user of the presence of the DM message if it is determined that the DM message suited to the user's attributes exists, based on a result of the detection of the mobile terminal 20 by the MFP 10. Moreover, the content provision system 1 causes the MFP 10 to print the DM message based on the operation input by the user.

### (3.1.2) If MFP is Used by User

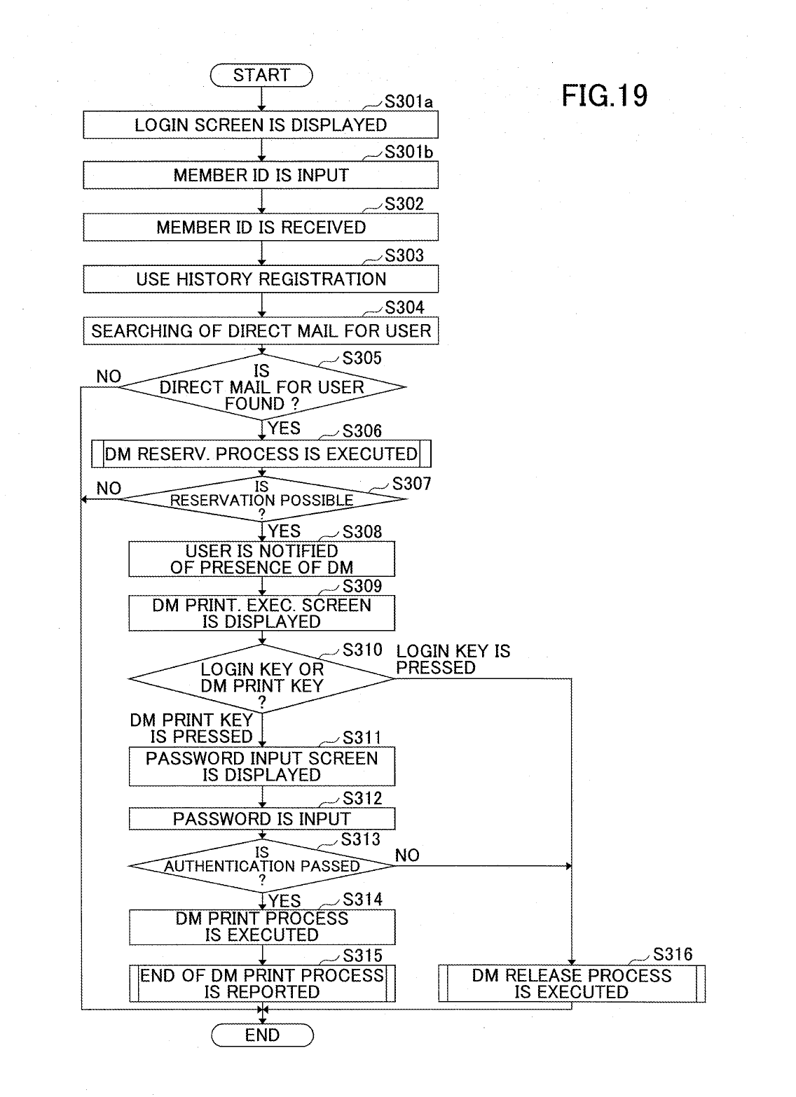

FIG. 19 is a flowchart for explaining a DM printing process performed when the MFP 10 is used by the user. In the flowchart of FIG. 19, steps which are essentially the same as corresponding steps in the flowchart of FIG. 16 are designated by the same reference numerals, and a description thereof will be omitted.

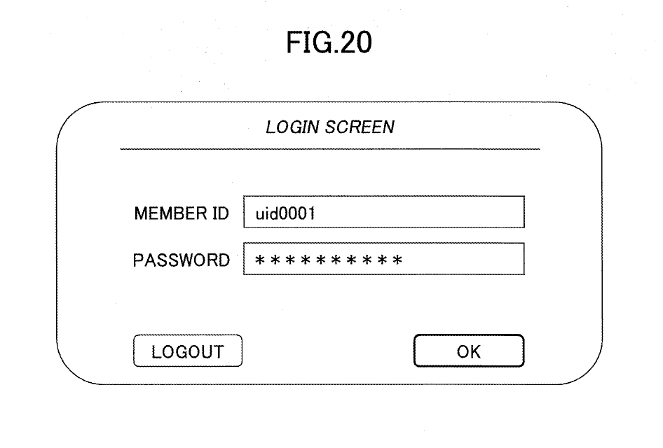

In the flowchart of FIG. 19, a login screen as shown in FIG. 20 is first displayed on the operation panel 1010 of the MFP 10 (S301a). Subsequently, a member ID is input by the user based on the login screen (S301b). Steps S302-S316 of the DM printing process shown in FIG. 19 are the same as the steps S302-S316 of the DM printing process shown in FIG. 16, and a description thereof will be omitted.

### (3.2) Process of DM Management Server

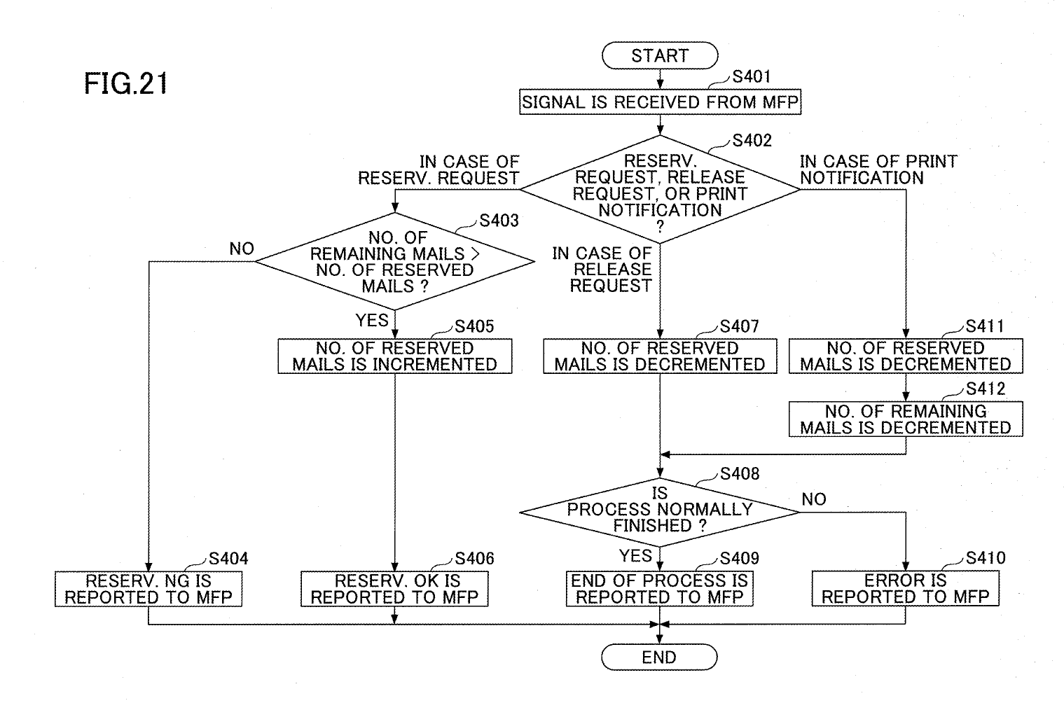

FIG. 21 is a flowchart for explaining a DM count control process performed by the DM management server 50.

As shown in FIG. 20, the DM output management unit 54 of the DM management server 50 first receives a signal from the MFP 10 (S401), and determines whether a type of the received signal is a reservation request, a release request, or a print notification” (S402).

When the type of the received signal is a reservation request, the DM output management unit 54 determines whether the number of remaining mail messages is greater than the number of reserved mail messages, both the numbers being stored in the DM information storage unit 55 (S403).

When the number of remaining mail messages is not greater than the number of reserved mail messages (NO in step S403), the DM output management unit 54 sends a notification indicating the reservation NG to the MFP 10 (S404). On the other hand, when the number of remaining mail messages is greater than the number of reserved mail messages (YES in step S403), the number of reserved mail messages stored in the DM information storage unit 55 is incremented (S405), and the DM output management unit 54 sends a notification indicating the reservation OK to the MFP 10 (S406).

When the type of the received signal is a release request in step S402, the number of reserved mail messages stored in the DM information storage unit 55 is decremented (S407). Subsequently, the DM output management unit 54 determines whether the DM count control process is normally finished (S408). When the process is normally finished (YES in step S408), the DM output management unit 54 sends a notification indicating the end of the process to the MFP 10 (S409). On the other hand, when the process is not normally finished (NO in step S408), the DM output management unit 54 sends a notification indicating the error to the MFP 10 (S410).

When the type of the received signal is a print notification in step S402, the number of reserved mail messages stored in the DM information storage unit 55 is decremented (S411), and the number of remaining mail messages stored in the DM information storage unit 55 is decremented (S412). After the step S412 is performed, the control is transferred to the step S408 above.

By performing the above-described process, the DM management server 50 manages the number of the DM messages distributed.

As described in the foregoing, the content provision system 1 according to the embodiment is arranged to manage the use history of the MFP 10 by the user (including the user whose mobile terminal in the vicinity of the MFP 10 is detected by short range radio communication). The content provision system 1 determines the target user as the object of provision of the content and the MFP 10 for distributing the content based on the attributes and the use history which indicate the target of the content (DM). The content provision system 1 sends a notification indicating the presence of the content to the user if the target user as the object of provision of the content distributed to the MFP 10 is detected by the MPF 10. Based on the notification, the user may operate the MFP 10 to output the content (printing).

Thereby, the user may register the identification information (the member ID) to identify the user in the use history of the MFP 10 when the MFP function is actually used or when the user's mobile terminal is passed by in the range of the predetermined distance (for example, less than 5 m) from the MFP 10. The content is distributed to the MFP 10 based on the use history. Hence, if the content targeted at the user whose mobile terminal is located in the vicinity of the MFP 10 is already distributed to the MFP 10, a notification indicating the presence of the content may be sent to the user. Moreover, the user may output a printout of the content at the location where the notification is received.

Moreover, the content provision system 1 according to the embodiment performs the distribution control of the content based on the user identification information (the member ID). Hence, the content may be provided efficiently without using personal information, such as an email address or a postal address.

As described above, the short range radio communication in the content provision system 1 according to the embodiment may include not only the NFC communication but also the Bluetooth communication. When the Bluetooth communication is used for the short range radio communication, data communication over a distance of several meters may be carried out.

The present invention may be implemented in any convenient form, for example, using dedicated hardware, or a mixture of dedicated hardware and software. The present invention may be implemented as computer software implemented by one or more networked processing apparatuses. The network may comprise any conventional terrestrial or wireless communications network, such as the Internet. The processing apparatuses may comprise any suitably programmed apparatuses such as a general purpose computer, personal digital assistant, mobile telephone (such as a WAP or 3G-compliant phone) and so on. Since the present invention may be implemented as software, each and every aspect of the present invention thus encompasses computer software implementable on a programmable device.

The computer software may be provided to the programmable device using any storage medium for storing processor readable code such as a floppy disk, hard disk, CD-ROM, magnetic tape device or solid state memory device.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

According to the present invention, it is possible to provide a content provision system which provides content, such as an advertisement, effectively and efficiently using use history of a user's electronic device.

The content provision system according to the present invention is not limited to the above-described embodiments, and variations and modifications may be made without departing from the scope of the present invention.

The present application is based upon and claims the benefit of priority of Japanese Patent Application No. 2013-116698, filed on Jun. 3, 2013, the contents of which are incorporated herein by reference in their entirety.

What is claimed is:

1. A content provision system comprising:
an electronic device; and
a management system including one or more devices to manage content that is provided to a user through the electronic device,
wherein the electronic device includes
a detection unit configured to detect a user who has used the electronic device and to receive user identification information that identifies the user, and
a transmission unit configured to transmit the user identification information received by the detection unit to the management system, and
the management system includes
a history management unit configured to manage history information which associates the user identification information transmitted by the transmission unit with the electronic device in which the user is detected by the detection unit, and
a determination unit configured to determine the electronic device to distribute the content, and the user as an object of provision of the content based on content attributes indicating the object of provision of the content and the history information managed by the history management unit.

2. The content provision system according to claim 1, wherein, when a mobile medium that stores the user identification information is located in a range of a predetermined distance from the electronic device, the detection unit receives the user identification information from the mobile medium.

3. The content provision system according to claim 1, wherein the electronic device further includes a user notification unit configured to notify the user corresponding to the user identification information received by the detection unit that the content is present in the electronic device, when the user is detected as being the object of provision of the content distributed to the electronic device.

4. The content provision system according to claim 3, wherein the user notification unit is configured to notify the user of the presence of the content in the electronic device by sound.

5. The content provision system according to claim 3, wherein the user notification unit is configured to display a message indicating the presence of the content in the electronic device on a display provided in the electronic device.

6. The content provision system according to claim 1, wherein:
the content attributes include distribution location information indicating a location of an object of distribution of the content;
the history information includes installation location information indicating an installation location of the electronic device; and
the determination unit is configured to determine the electronic device that stores the installation location information corresponding to the distribution location information as being the electronic device to distribute the content.

7. The content provision system according to claim 1, wherein:
the content attributes include user attribute information of the object of provision of the content;
the history information includes user attribute information of the user corresponding to the user identification information received by the detection unit; and
the determination unit is configured to determine the user as being the object of provision of the content based on the user attribute information included in the content attributes and the user attribute information included in the history information.

8. The content provision system according to claim 2, wherein the mobile medium is configured to perform short range radio communication with the electronic device and the detection unit is configured to receive the user identification information from the mobile medium by performing the short range radio communication with the mobile medium.

9. A content provision system comprising:
an image processing apparatus to output content that is provided to a user; and
a management system including one or more devices to manage the content,
wherein the image processing apparatus includes
a detection unit configured to detect a user who has used the image processing apparatus and to receive user identification information that identifies the user, and
a transmission unit configured to transmit the user identification information received by the detection unit to the management system, and
the management system includes
a history management unit configured to manage history information which associates the user identification information transmitted by the transmission unit with the image processing apparatus in which the user is detected by the detection unit, and
a determination unit configured to determine the image processing apparatus to distribute the content, and the user as an object of provision of the content based on content attributes indicating the object of provision of the content and the history information managed by the history management unit.

10. A distribution control method for distributing content from a management system including one or more devices that manage the content to an electronic device that outputs the content, comprising:
detecting, by the electronic device, a user who has used the electronic device to receive user identification information that identifies the user;
transmitting, by the electronic device, the user identification information received in the detecting to the management system;
managing, by the management system, history information which associates the user identification information transmitted in the transmitting with the electronic device in which the user is detected in the detecting; and
determining, by the management system, the electronic device to distribute the content, and the user as an object of provision of the content based on content attributes indicating the object of provision of the content and the history information managed in the managing.

11. The distribution control method according to claim 10, wherein the detecting includes receiving, when a mobile medium that stores the user identification information is located in a range of a predetermined distance from the electronic device, the user identification information from the mobile medium.

12. The distribution control method according to claim 10, further comprising:
notifying, by the electronic device, the user corresponding to the user identification information received in the detecting that the content is present in the electronic device, when the user is detected as being the object of provision of the content distributed to the electronic device.

13. The distribution control method according to claim 12, wherein, in the notifying, the user is notified of the presence of the content in the electronic device by sound.

14. The distribution control method according to claim 12, wherein, in the notifying, a message indicating the presence of the content in the electronic device is displayed on a display provided in the electronic device.

15. The distribution control method according to claim 10, wherein:
the content attributes include distribution location information indicating a location of an object of distribution of the content;
the history information includes installation location information indicating an installation location of the electronic device; and
the determining includes determining, by the management system, the electronic device that stores the installation location information corresponding to the distribution location information as being the electronic device to distribute the content.

16. The distribution control method according to claim 10, wherein:
the content attributes include user attribute information of the object of provision of the content;
the history information includes user attribute information of the user corresponding to the user identification information received by the detection unit; and
the determining includes determining, by the management system, the user as being the object of provision of the content based on the user attribute information included in the content attributes and the user attribute information included in the history information.

17. The distribution control method according to claim 11, further comprising:
performing, by the mobile medium, short range radio communication with the electronic device,
wherein the detecting includes receiving, by the electronic device, the user identification information from the mobile medium by performing the short range radio communication with the mobile medium.
